(19) United States
(12) Patent Application Publication
(10) Pub. No.: US 2003/0223738 A1
(43) Pub. Date: Dec. 4, 2003

(54) Method and system for solid state DC crane control

(76) Inventors: Ronald Wayne Hughes, Thompson, OH (US); Michael Owen Lucas, Franksville, WI (US)

Correspondence Address: Roylance, Abrams, Berdo & Goodman, L.L.P., Suite 600, 1300 19th Street, Washington, DC, 20036, US

(21) Appl. No.: 10/157,024

(22) Filed: May 30, 2002

(51) Int. Cl. H02P 5/00

(52) U.S. Cl. 388/800; 318/376; 318/66

(57) ABSTRACT

A method and system for DC motor control is provided. A processor controls transistors connected to the field and armature coils of a DC motor, and measures the current and average voltage associated with said field and armature coils to determine motor speed. Motor speed is compared to a speed command to determine a speed error. The torque of the motor is adjusted to reduce the speed error. Safety features and power redistribution features are also provided.

### FIELD OF THE INVENTION

The invention is related to solid state direct current (DC) crane controls. More specifically, the invention is related to a solid state DC crane control with improved performance, efficiency, and safety features.

### BACKGROUND OF THE INVENTION

Most DC overhead traveling cranes in use today are powered with a 250 volt DC rectifier or motor-generator set located in the plant. This power is delivered to the crane via sliding collector bars. The cranes typically employ a series wound DC motor, controlled by changing the resistance in series with the motor. The circuit generally uses three to five resistors that are switched with high voltage DC contacts.

Although this system has served the industry for decades, it has several disadvantages. First, the speed of the hoist is dependent on the load. As a result, low speed operations require a technique known as jogging or plugging, and a skilled operator is required to operate the crane. Second, the control resistors waste energy. Third, the contacts for the resistors have a limited lifetime. Finally, the brake requires maintenance as it wears from capturing moving loads.

The performance of DC Overhead Traveling Cranes can be investigated by considering the type of system employed to control the motors of the individual crane motions. Traverse or travel motions such as Bridge and Trolley are primarily concerned with positioning of the lifting hook or mechanism in the X and Y directions. The size of the travel motor is determined by acceleration/deceleration and duty cycle requirements. The typical running motor loads are frictional and will be in the 15% to 30% range. Hoist motions are termed constant torque applications because they must perform work against gravity and position loads in the Z direction. The size of these motors will be determined by the load weight and the speed that the load must be lifted.

Over the years, many different systems have been developed to control the motors on DC cranes. By assigning broad categories for these systems, they can be placed generally into stepped contactor controls and into stepless “static” systems.

The majority of DC Contactor Control systems were designed to control the DC Series motor. This motor provides high torque and high-speed capabilities though not generally at the same time. When properly applied, this motor offers excellent performance characteristics and high duty cycles for material handling cranes.

Simple reversing/plugging control is typically supplied for travel motions. This type of control uses contactors to remove or insert resistance in the series connected armature and field circuit. This method establishes discrete control points by limiting the amount of torque available from each step. Further, the torque is approximately inversely proportional to speed for each of the control steps. Since the loading varies little for travel drives, and the motors are sized for acceleration torque, these characteristics provide for efficient acceleration to full rated speed, but lack the ability to provide controlled slow speed operation. Because of these characteristics, it is quite common, if not necessary, to “Jog” and “Plug” this type of control when low speed operation is required for accurate positioning.

For Hoist motions, the DC Dynamic Lowering control is almost universally used. This control provides safe, proven control of DC Series motors for constant torque hoist loads. In the hoisting direction, raising the load against gravity, the control is essentially equivalent to the reversing plugging control described above. In the lowering direction, where gravity is accelerating the load, the role of the motor is to control the decent through DC Dynamic braking. In this configuration, the DC Series motor is operated essentially as a shunt motor with separate armature and field circuits. This method provides improved per step speed regulation, but the poor load regulation provided by each step can still lead to large differences in operating speed as a function of the load being handled. Again, “Jogging” is often required to position loads.

1. Contactor Control Characteristics

Discrete stepped contactor control of DC motors limits the torque that the connected DC Series motor can provide for any given control step. Because of this, the resulting speed on any given control step is strongly a function of the load presented to the motor. This poor load regulation characteristic tends to allow the motor to try run at full speed under reduced or minimum loads.

Stepped contactor systems consist of several mechanical contactors that are “visible control” components. These components provide simple direct control of the motor's power circuit in a manner that can be observed directly. These devices require periodic maintenance and attention to insure continued high levels of service. The “Jogging” and “Plugging” operations necessary for these types of systems increase the need for periodic maintenance and inspection.

The currents associated with Jogging and Plugging for each type of control will be different due to the nature of the motor's power circuit. In DC Series motor travel systems, the M and directional contactors close on a circuit defined by the motor's inductive characteristic along with some effective series resistance. This combination results in well-defined Jogging and Plugging currents that rise from zero to the controlled circuit value, typically in the 50% to 100% range.

DC Series motor hoist systems produce similar levels of Jogging currents for hoist operations. However, much higher levels of contactor current are associated with a full speed plug-reversal of the DC Dynamic Lower Hoist Control. Because of this, a full speed plug-reversal should not be permitted as a normal operational procedure. The Off-Point Dynamic Braking Torque is greater than the first point plugging torque and stops the descending load much more efficiently.

2. DC Adjustable Speed Systems

The lack of precise speed control for many crane applications led to the development of adjustable voltage, adjustable speed systems. Initially these systems consisted of a DC Shunt motor controlled by a dedicated adjustable voltage generator. These Ward-Leonard controls were eventually replaced by “Static SCR” systems providing rectified adjustable voltage. The DC Shunt motor was retained due to its excellent speed and load regulation characteristics. The newer static SCR systems provided a means to precisely operate the DC Shunt motor from standstill to beyond rated full speed with good torque and speed control. Travel as well as hoist control applications are possible with this system. The static SCR Adjustable Voltage Control has the capability of delivering overhauling motor power back to the AC supply system. This ability permits hoist control schemes to be implemented without external load brakes. The improvement in speed control was also accompanied by a reduction in the number of the power circuit contactors. Both travel and hoist applications benefited from improved slow speed operation down to and including stall. With static DC systems, movement could now be accurately controlled regardless of load variations, even at slow speeds. Additionally, these movements could be made more precisely without “Jogging” or “Plugging”. The benefit here is smoother load motion and reduced mechanical wear and arc erosion of the remaining power contactors.

The operation of these static SCR DC systems result in non sinusoidal load currents being drawn from the AC supply and distortion (line notching) of the AC supply voltage due to SCR phase commutation. These effects and possible interaction with other equipment can be reduced somewhat by the inclusion of an isolation transformer or AC line reactors.

3. Adjustable Speed Control Characteristics

Stepless adjustable speed systems provide several unique characteristics. The most obvious of these is the ability to operate the motor at reduced speeds and to do so with precise control, even down to stall conditions. This ability eliminates the necessity of “Jogging” and “Plugging” for the positioning of loads at low speeds. Also, adjustable speed systems will reduce the number of “visible” control elements such as power circuit contactors, and replace them with “invisible” static elements. These two characteristics combine to reduce the amount of periodic mechanical maintenance required to keep a system operational, but increases the level of system complexity and specific knowledge required to keep the equipment functional.

Another area of concern is that of motor thermal performance. All motors have inefficiencies and must dissipate heat in the performance of their duties. Motor self ventilation via internal fans is the most common method of removing this heat. Adjustable Speed Systems with their ability to operate motors at dramatically reduced speeds can severely affect the motor's ability to cool itself. As with repetitive “Jogging” and “Plugging” in contactor systems, continuous slow speed operations with Adjustable Speed Systems should be avoided unless the system is specifically designed for this service.

4. DC to DC Adjustable Speed Systems

Another type of adjustable speed system for DC Overhead Cranes is possible. This system utilizes DC input power to control a DC motor, series or shunt. The advantage of this system lies in its ability to utilize existing DC crane power and existing DC crane motors to provide improved levels of performance and positioning accuracy. This system replaces the traditional contactors and resistors used to control developed motor torque with solid state devices, and provides improved levels of speed and torque control. This system also allows energy to be recovered from one operating motor and delivered to another thus reducing the overall crane power requirements.

Stepped Contactor systems provide simple “visible” control of the motor's power circuit. These systems provide open loop control of the developed motor torque, and as such, the motor speed will be determined by the load torque. Stepped Contactor systems will tend to operate the motor at or near full speed with light loads, thus requiring “Jogging” and “Plugging” for slow speed positioning. The currents associated with this intermittent service will be well defined and controlled for DC contactor systems.

Adjustable Speed systems reduce the number of “visible” power circuit control elements and provide closed loop control of motor speed. This permits controlled slow speed operation independent of load and eliminates the necessity for “Jogging” and “Plugging”. Also, Adjustable Speed systems permit DC motors to be operated at reduced speeds for prolonged periods. This capability reduces the motor's ability to cool, requiring careful system design should this be an operational requirement.

### SUMMARY OF THE INVENTION

A system for controlling a DC motor according to an embodiment of the present invention comprises a DC power bus comprising a first bus terminal and a second bus terminal. The system further comprises a first field transistor connected in series with a first flyback diode at a field terminal, the first field transistor and the first flyback diode being connected between the first and second bus terminals, and a field coil connected in series with a brake coil, the field and brake coil connected between the field terminal and a first armature terminal. Furthermore, the system includes a first current sensor adapted to detect the current flowing through the field coil. The system is provided with a first armature transistor connected in series with a second armature transistor at the first armature terminal, the first and second armature transistors being connected between the first and second bus terminals, the first armature transistor connected in parallel with a second flyback diode, and a third armature transistor connected in series with a fourth armature transistor at a second armature terminal, the third and fourth armature transistors being connected between the first and second bus terminals, the third armature transistor connected in parallel with a third flyback diode. Furthermore, an armature coil is connected between the first armature terminal and the second armature terminal, and a second current sensor adapted to detect the current flowing through the armature coil. The system is provided with a processor adapted to receive a speed command, to determine a motor speed based on the current flowing through the field coil, the current flowing through the armature coil, and an average voltage across the armature coil, to control the first field transistor to change the current through the field coil towards a field coil current set point, to calculate a speed error based on the speed command and the determined motor speed, and to control the first, second, third, and fourth armature transistors to reduce the speed error.

According to another embodiment of the invention, a method of controlling a DC motor is provided. The method is used in conjunction with a DC motor control system comprising a DC power bus comprising a first bus terminal and a second bus terminal, a first field transistor connected in series with a first flyback diode at a field terminal, the first field transistor and the first flyback diode being connected between the first and second bus terminals, and a field coil connected in series with a brake coil, the field and brake coil connected between the field terminal and a first armature terminal. The system further includes a first current sensor adapted to detect the current flowing through the field coil, a first armature transistor connected in series with a second armature transistor at the first armature terminal, the first and second armature transistors being connected between the first and second bus terminals, the first armature transistor connected in parallel with a second flyback diode, a third armature transistor connected in series with a fourth armature transistor at a second armature terminal, the third and fourth armature transistors being connected between the first and second bus terminals, the third armature transistor connected in parallel with a third flyback diode, an armature coil connected between the first armature terminal and the second armature terminal, and a second current sensor adapted to detect the current flowing through the armature coil. The method comprises the steps of receiving a speed command, determining a motor speed based on the current flowing through the field coil, the current flowing through the armature coil, and an average voltage across the armature coil, controlling the first field transistor to change the current through the field coil towards a field coil current set point, calculating a speed error based on the speed command and the determined motor speed, and controlling the first, second, third, and fourth armature transistors to reduce the speed error.

### BRIEF DESCRIPTION OF THE DRAWINGS

The invention will be more readily understood with reference to the attached figures, in which:

FIG. 1 is a circuit diagram showing a motor controller according to an embodiment of the present invention;

FIGS. 2(a) and 2(b) are depictions of two states of an inverter according to an embodiment of the invention;

FIGS. 3(a) and 3(b) depict armature current in an inverter according to an embodiment of the present invenion;

FIG. 4 illustrates a hoist inverter according to an embodiment of the present invention;

FIG. 5 illustrates the dynamic brake resistor grid portion of an embodiment of the present invention;

FIG. 6 illustrates power redistribution in a system according to an embodiment of the present invention including a blocking diode and a dynamic brake resistor grid;

FIG. 7 illustrates power redistribution in a system according to an embodiment of the present invention including a dynamic brake resistor grid, but no blocking diode; and

FIG. 8 illustrates power redistribution in a system according to an embodiment of the present invention having a motor-generator set, no dynamic brake resistor grid, and no blocking diode.

In the figures, it will be understood that like numerals refer to like features and structures.

### DETAILED DESCRIPTION OF THE PREFERRED EMBODIMENTS

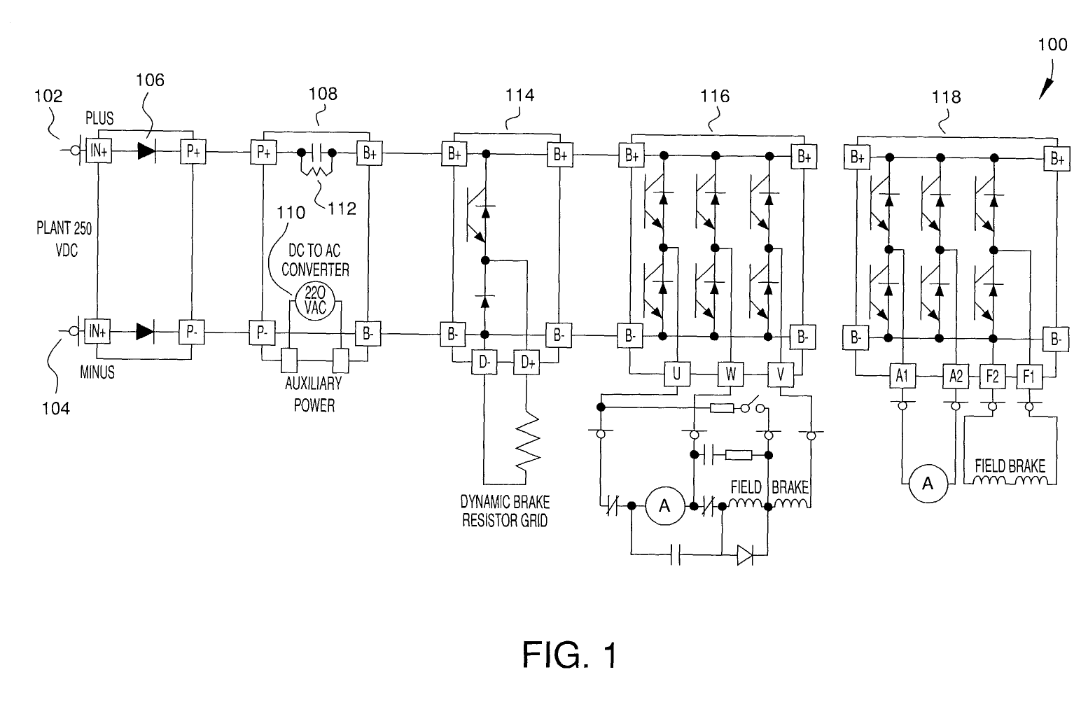

The invention will now be described with reference to the attached figures. FIG. 1 is an illustration of a solid state DC motor controller 100 adapted for use with an overhead traveling crane according to an embodiment of the invention. The motor controller 100 is fed with 250 DC voltage from the plant through collector bars 102, 104. The controller has five main components. The first is blocking diode 106. The blocking diode 106 prevents current from returning to the plant from the controller 100. The second component of the controller 100 is a DC slow charge and auxiliary power unit 108. The auxiliary power portion 110 comprises a DC to AC converter, and supplies 220V AC power to auxiliary devices. The DC slow charge unit 112 limits current to prevent damage to the other components. The next component in the exemplary controller 100 is a dynamic brake 114, which will be described in further detail below. A hoist inverter 116 is used to control the vertical motion of the crane. Finally, a travel inverter 118 is used to control the travel movements of a crane. Typically there are at least two travel inverters for controlling motors for movement in the x and y directions, referred to as bridge and trolley, respectively.

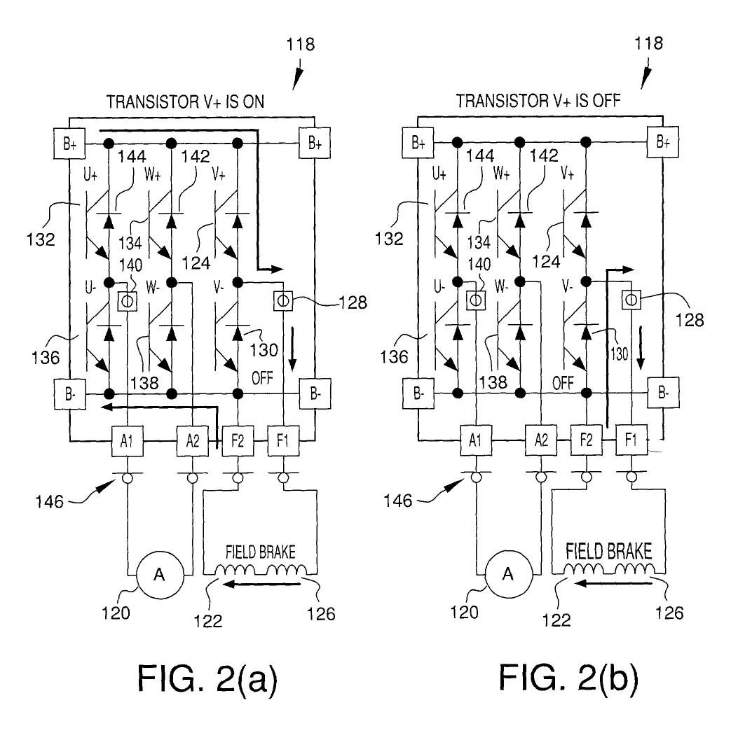

Trolley inverter 118 is shown in greater detail in FIG. 2. The inverter 118 can advantageously be used to replace typical contactor/resistor control in existing crane motors. As will be described below, the inverter 118 controls the voltage and current to the motor using transistors in a technique called pulse width modulation (PWM).

It should be noted that the present invention is particularly advantageous for retrofitting existing series wound DC motor controllers. The motor is reconnected as a shunt motor, as shown in FIG. 2(a). The armature 120 and field 122 windings are both connected across the plant supply voltage in parallel through transistors. Other elements of the existing crane, such as the plant DC power, the series motors, collector bars, and the brakes are reused once reconfigured according to the invention.

A typical shunt motor has many turns of wire in the field coil which directly connect to the 250 volt bus. The resistance in this type of field winding controls the magnitude of the field current, typically a few percent of the rated armature current. Series motor field windings, however, typically have far fewer turns of thicker wire than the shunt motor and have a current rating equal to the armature rating. Only a few volts across the field winding of a series motor is required to produce the rated field current.

According to the present invention, a microprocessor (not shown) controls transistors in a PWM scheme to efficiently deliver rated field current to a series motor without the need for a series resistor. The transistors alternately connect the field coil to the 250 volt bus and then short the coil as will be described in further detail below.

B+ and B− terminals shown in FIG. 2(a) are connected to the plant DC power source. Transistor 124 is turned on to allow current to flow through the brake coil 126 and field coil 122. Current increases according to the inductance of the brake and field coils, and is measured by current sensor 128. Once the current through current sensor 128 reaches the desired set point, transistor 124 is turned off. Inductive current continues to be forced through brake coil 126, field coil 122, and flyback diode 130 while transistor 124 is turned off, as shown in FIG. 2(b). The magnitude of the current decays according to the inductive and resistive values of the brake coil 126 and field coil 122. Once the current sensor 128 detects current below the set point, transistor 124 is once again turned on. In this manner, the current through brake coil 126 and field coil 122 is maintained near the set point, with a small ripple current above and below the set point as the transistor 124 is turned on and off. As a result of the PWM action of the transistor 124, the frequency of the ripple about the set point is on the order of a few kilohertz, and the average current drawn from the plant supply for use by the field coil is small compared to the actual field current.

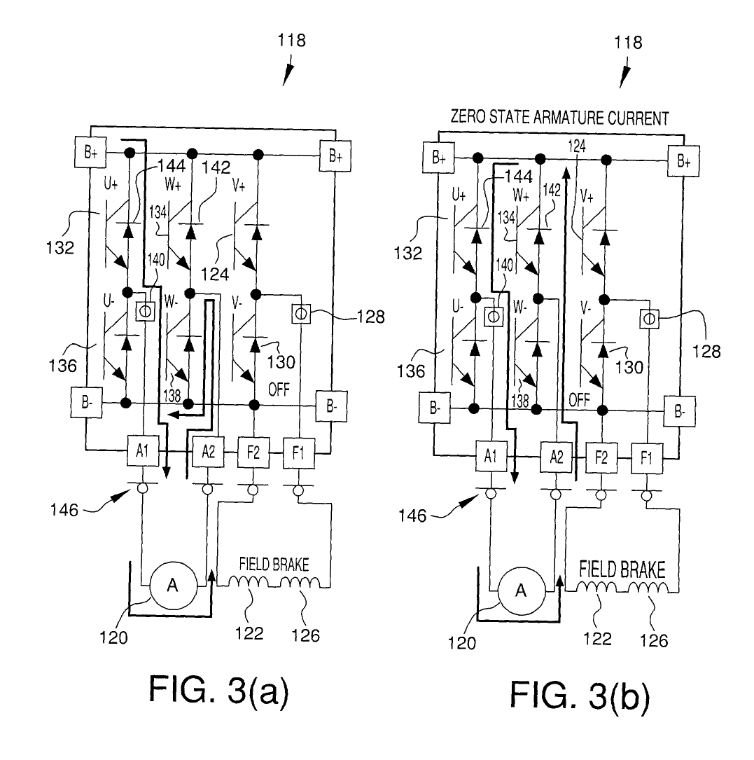

Armature 120 is similarly controlled with transistors 132 through 138. As shown in FIGS. 3(a) and 3(b) transistors 132 through 138 are capable of controlling motor current through the armature 120 in both directions. As shown in FIG. 3(a) current is increased in one direction by turning transistors 132 and 138 on. Current flows through transistor 132 through current sensor 140, through armature 120 in the direction indicated, through terminal A2, and finally through transistor 138 returning to the plant through terminal B−. Once the current reaches the set point, transistor 138 is turned off, as shown in FIG. 3(b), and inductive current continues to flow through the armature is redirected through flyback diode 142 in the direction indicated. Current in the armature 120 decays according to the RL constant until the microprocessor detects that the current through sensor 140 has fallen below the set point. The transistor 138 is then turned on to maintain the current at the set point.

In order to increase armature current in the opposite direction (not shown) transistors 134 and 136 are turned on. In this manner, current flows from positive terminal B+ through transistor 134, through terminal A2, through armature 120, through terminal A1, through current sensor 140, and finally through transistor 136 returning to the plant through terminal B−. Once the current sensor 140 senses the current is at the set point, transistor 136 is turned off and inductive current continues to flow through flyback diode 144. As with the brake and field coils, the switching of transistors 132 through 138 allows the current through armature 120 to be maintained with a small ripple current about the set point.

The microprocessor controls the motor torque by setting the product of the armature 120 and field 122 current, as measured by current sensors 140 and 128, respectively. Also, as the transistor states switch, the voltage across the motor terminals alternates between the bus voltage and zero volts. The time average of this voltage along with the armature current is used by the microprocessor to estimate the speed of the motor. In this manner, the operator can directly command speed of the motor independent of the load. The microprocessor calculates the difference between the speed command and the actual speed estimate. The speed error is used to calculate a torque command to minimize the speed error. The speed control automatically compensates for torque disturbances caused by friction or other loads.

The trolley inverter 118 is connected to the trolley motor using four collector bars shown generally at 146. This configuration is advantageous in that the four electric rails typically found on existing DC cranes can be retrofitted with a control system according to an embodiment of the present invention. Furthermore, the field 122 and brake 126 coils are in series, such that when the field coil 122 is energized, the brake coil 126 is also energized forcing the brake open. Once the inverter brings the motor to a stop, the field and brake current is extinguished as the inverter turns off. The brake closes a split second after a motor is brought to rest, as the brake coil 126 de-energizes.

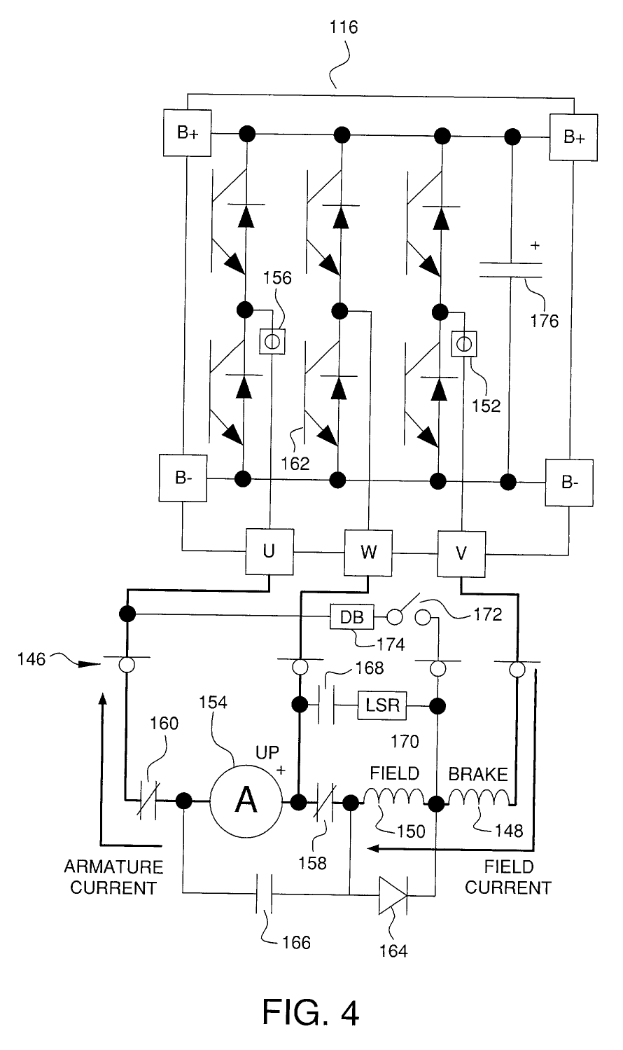

The hoist inverter 116 controls a hoist motor, which is used to raise and lower loads. The hoist also has four collector bars, shown generally at 146, connecting the inverter 116 to the hoist motor. Due to a power limit switch safety circuit, which is located on the motor side of the collector bars of an existing hoist, the inverter configuration shown in FIGS. 3(a) and 3(b) cannot be used for the hoist. As shown in FIG. 4, the hoist has only three connections to the inverter labeled terminals U,W and V, respectively.

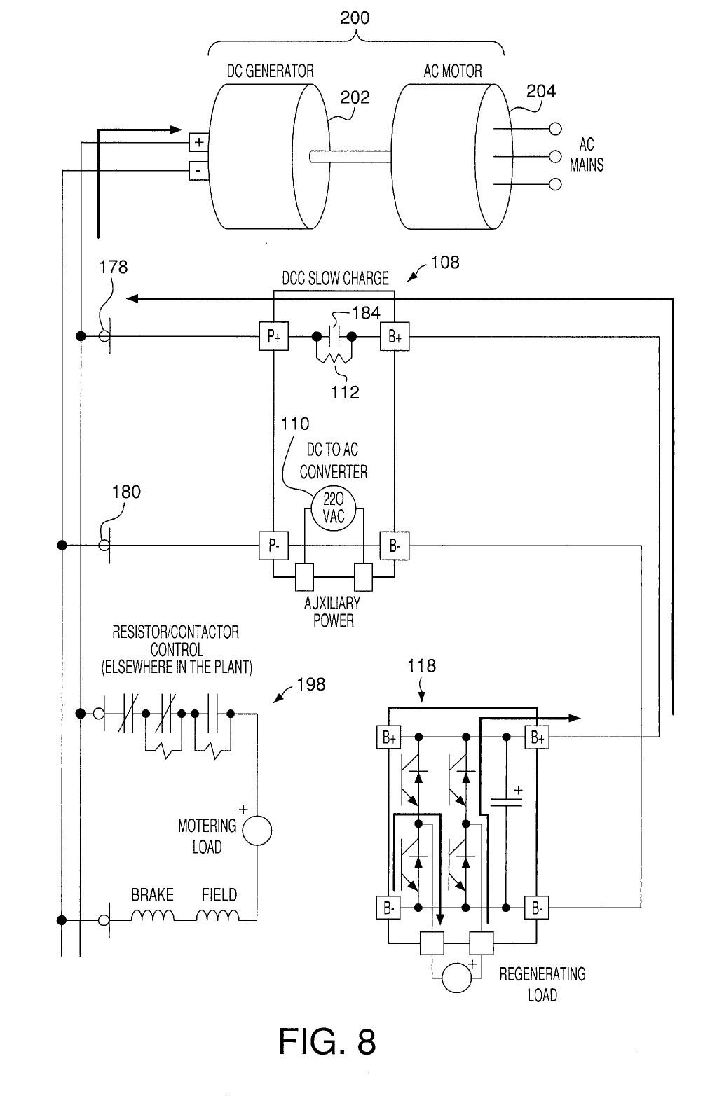

Under normal conditions current through the field, brake, and armature portions of the hoist motor are limited to the U, W, V phases indicated in FIG. 8 by thick lines. Current through the brake coil 148 and through field coil 150 is controlled with the V phase of the inverter. The magnitude of the field current is usually constant and is equal to the armature current rating. Current sensor 152 measures the current through the V phase of the inverter. Current through armature 154 can be in either direction but under normal conditions is it in the direction indicated by the arrow, and returns to the inverter through terminal U, and is measured by current sensor 156.

Under normal circumstances, power limit switches 158 and 160 are closed so the current flows in the conductors shown with thick lines. Under light load conditions, the armature current is small such that most of the field current returns through terminal W and transistor 162. Under heavier load conditions, larger armature current is required and the majority of field current assists the armature such that smaller current returns to the W phase. Under light to heavy load conditions, the magnitude of current in the U and W phases is less than that in the V phase, and also less than the rated of motor current. However, under the worst case load for the inverter, when an empty hook is driven down, friction requires that a small armature current be in the opposite direction than shown by the arrow. Under these conditions, the W phase carries the large field current plus the small armature current.

The operator of the hoist sends speed commands to the hoist which the microprocessor compares to the estimated motor speed. The speed estimate is calculated by the microprocessor from motor voltage and current signals. The speed error is used to adjust the torque command to the inverter. Once again, speed is controlled directly, independent of the weight on the hoist. Speed can be controlled to within a few percent of rated motor speed without the aid of a feedback device.

Safety Features

At the end of a move, the load is supported by the torque of the hoist motor at zero speed. This is known as “load floating”. When the “V” phase current is zero, the field weakens as the brake closes. It is possible that as the field current decays, and prior to the brake engaging, the load could drop a small distance. In order to prevent this, a flyback diode 164 is wired in parallel with the field coil as shown in FIG. 4. Thus, as the V phase current is zero closing the brake, the field current slowly decays around the diode path. The remaining armature current ensures that the load is supported by the motor past the time that the brake engages.

Another safety feature included according to an embodiment of the present invention is a “power limit switch” circuit as shown in FIG. 4. Without the power limit switch, if the hoist is moved past, its upper mechanical limit, it is possible for the motor to cause the cable to break resulting in an unsupported load which would uncontrollably fall in a dangerous manner. According to an embodiment of the present invention, a power limit switch is mechanically activated if the hoist is moved too close to its upper limit. The switch in turn opens two normally closed contacts 158, 160 and closes two normally open contacts 166, 168. With contacts 158 and 160 open and contacts 166 and 168 closed, motor current is redirected through limit switch resistor 170, dissipating the motor energy. Furthermore, because contact 160 is opened, the armature current through terminal U immediately halts, and current sensor 156 senses zero current indicating that the power limit switch has been activated. The microprocessor in turn switches off the inverter such that the current through terminal V is turned off causing the brake 148 to engage.

Another safety feature in accordance with an embodiment of the present invention is dynamic lowering. When the hoist is on, “INV OFF” contact 172 is open, removing the dynamic brake resistor 174 from the circuit. When the hoist is turned off, this contact 174 is closed establishing the dynamic lowering circuit. Should the mechanical brake fail with the load on the hook while the hoist is turned off, the hoist motor will begin to turn as the load moves down. The spinning motor will generate a voltage and current that opposes the motion of the motor. The energy generated by this motion is dissipated in the dynamic brake resistor 174. Thus, the load will lower, but at a limited speed.

Power Management

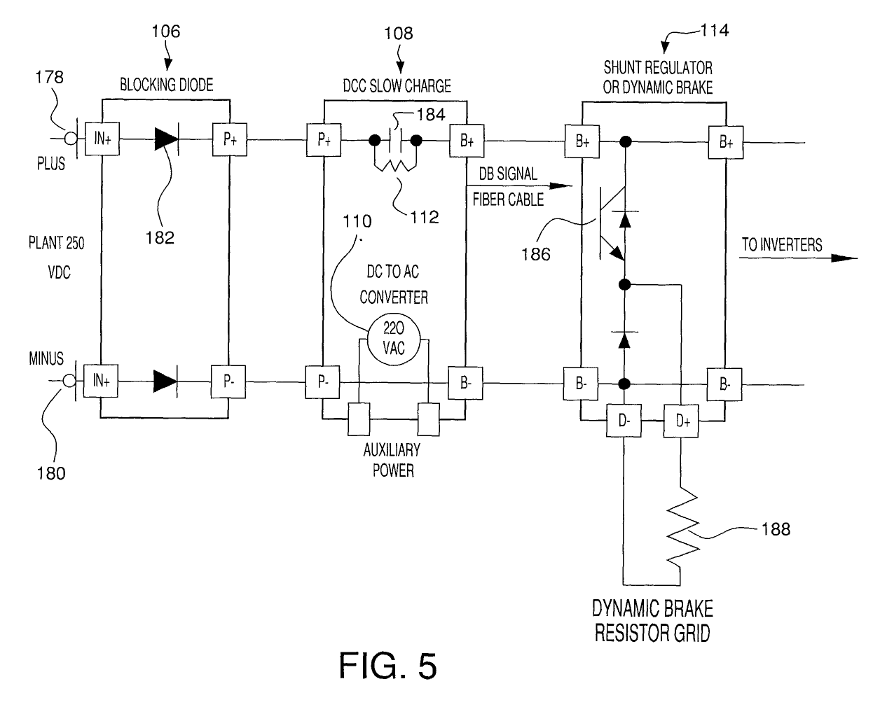

A hoist lowering a heavy load or a bridge or trolley that is decelerating generates electrical energy. Bus capacitors 176 located in the inverters momentarily absorb some of this energy as the bus voltage is forced to rise but this energy must be deposited somewhere before the bus voltage rises too much. Depending on the nature of the crane system, several options exist for reusing this energy. The circuit in FIG. 5 contains devices designed to interface the inverters with the plant supply. The left side of the figure shows the collectors 178, 180 that connect to the plant supply. A blocking diode 182 allows power to pass to the right but protects the plant supply from higher voltages when the inverters are regenerating. The DC Contactor Control (DCC) slow charge 108 has a resistor 112 in parallel with a contact 184.

When first energized the resister prevents excessive in rush of current to the inverter's capacitors. When the inverter's bus voltage equals the plant voltage, the contact 184 closes. The DCC slow charge 108 also provides a DC to AC 220 V converter 110 which powers auxiliary equipment, such as fans and air conditioners, as well as a 24 V DC supply (not shown) which is available for radio control among other uses. The DCC slow charge 108 also measures the bus voltage. If regenerating inverters drive the bus above 315 V, a fiber optic signal is sent to dynamic brake 114. The signal causes transistor 186 to turn on allowing energy to dissipate in a dynamic brake resistor grid 188. When the crane system is regenerating, the blocking diode 182 prevents the high bus voltage from invading the plant supply.

Commercial inverters typically include the built-in dynamic brake resistors, slow charge, and rectifiers to accept AC power. These elements are redundant and multi-inverter crane systems or in some cases are not used. Often these elements can get in a way of the optimal system design. The embodiments described below illustrate and improved power distribution options.

Plant Supply Uses Rectifier, and Blocking Diode is Used

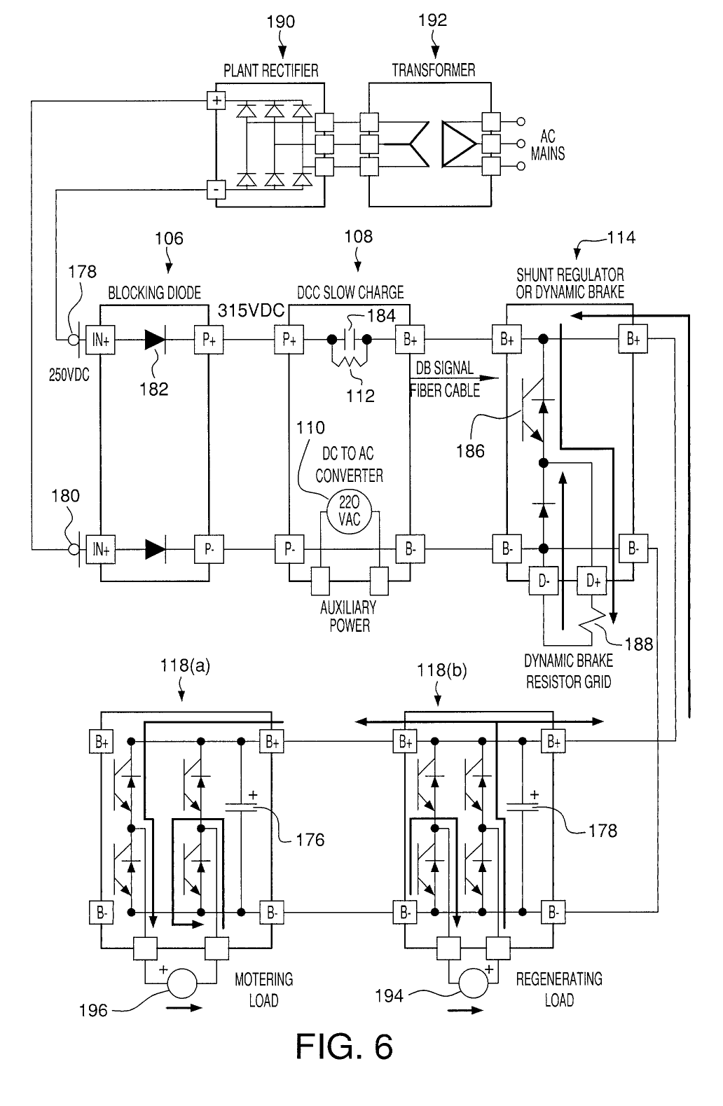

FIG. 6 illustrates an embodiment of the invention in which the solid state DC controller replaces a contact/resistor control in one or more cranes, but other equipment remains on the DC grid and must be protected from voltages greater than that provided by the plant's rectifier supply. The plant rectifier is shown at 190, and the plant transformer is shown in 192. Blocking diode 182 remains in the system to protect the plant from over-voltages. The inverters 118a and 118b shown in FIG. 6 are simplified somewhat in that the field coil portion of the circuit is omitted because it uses little energy.

Arrows in FIG. 6 show that the average current flow inside each inverter 118a, 188b is the sum of various switching patterns, as described previously. Local capacitors 176 in each inverter absorb the ripple voltage caused by the switching so that the current between the inverters and other devices is relatively constant. The inverters 118a and 118b shown in FIG. 6 are most efficient when in the motoring state, especially compared to a contact/resistor control system. This is especially true at less than maximum speed where a contractor/resistor system would dump energy into control resistors. If one motor 194 is regenerating, such as when a hoist is lowering a load or when a travel motor is slowing down, while the other inverters are turned off, the regenerated energy is dissipated in dynamic brake resistor grid 188. However, when inverters 118a, 118b share a common bus, there is a possibility for energy savings if one or more inverters are in the motoring state while another motor is regenerating.

In the illustrated example, inverter 118a shows the current flow for a regenerating motor. This energy is available for driving a motoring inverter 118b. In the optimal situation all of the current regenerated by inverter 118a is redirected to inverter 118b to be used by motoring motor 196. In a less than optimal situation, a portion of the regenerated current from the regenerating load 194 is also redirected and dissipated in a dynamic brake resistor grid 188.

Plant Supply Uses Rectifiers Blocking Diode Not Used

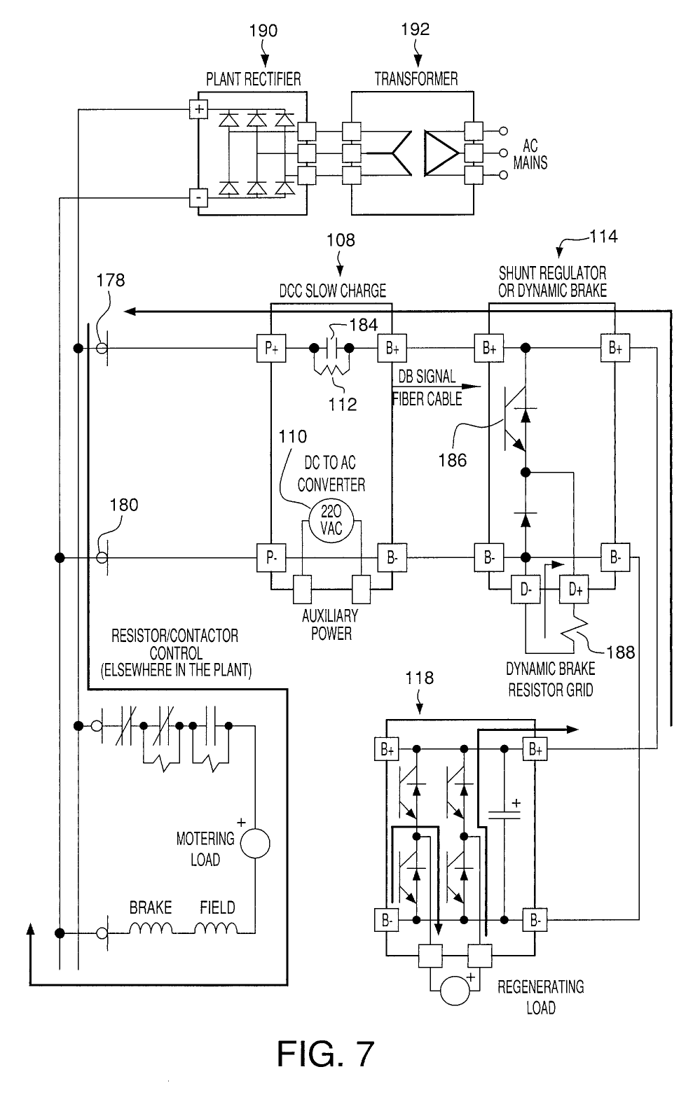

If it is determined that the equipment in the plant can tolerate 315 V, or if there is no other equipment than the solid state control on the plant's DC grid, then the blocking diode 182 can be eliminated from the system, as illustrated in FIG. 7. The more equipment present on the DC grid, the higher the probability that it will use regenerated energy from a solid state inverter. FIG. 7 illustrates this case. A solid state inverter 118 is regenerating energy and a resistor/contractor control 198 elsewhere in plant is using this. The dynamic brake resistor grid 188 remains in the circuit for the case where excess energy has no other place to go.

Plant Supply Uses a Motor-Generator Set

An even more efficient system for energy regeneration and reuse is possible in a plant where the DC grid is powered with a motor-generator set 200. The embodiment illustrated in FIG. 8 is such an example. In this case, both the blocking resistor and dynamic brake packages are eliminated from the system. An inverter 118 in regeneration, as shown, will drive the DC grid voltage up by a few volts. If other devices on the grid do not use this energy, the DC generator 202 will speed up along with its AC induction motor 204. Thus, the induction motor 204 will pass energy back to the AC mains.

While the invention herein disclosed has been described by means of specific embodiments and applications thereof, numerous modifications and variations could be made thereto by those skilled in the art without departing from the scope of the invention set forth in the claims.

What is claimed is:

1. A system for controlling a DC motor, comprising:
a DC power bus comprising a first bus terminal and a second bus terminal;
a first field transistor connected in series with a first flyback diode, said first field transistor and said first flyback diode being connected between said first and second bus terminals;
a field coil connected in series with a brake coil, said field and brake coil connected in parallel with said first flyback diode;
a first current sensor adapted to detect the current flowing through said field coil;
a first armature transistor connected in series with a second armature transistor at a first armature terminal; said first and second armature transistors being connected between said first and second bus terminals, said first armature transistor connected in parallel with a second flyback diode;
a third armature transistor connected in series with a fourth armature transistor at a second armature terminal, said third and fourth armature transistors being connected between said first and second bus terminals, said third armature transistor connected in parallel with a third flyback diode;
an armature coil connected between said first armature terminal and said second armature terminal;
a second current sensor adapted to detect the current flowing through said armature coil;
a processor adapted to receive a speed command, to determine a motor speed based on said current flowing through said field coil, said current flowing through said armature coil, and an average voltage across said armature coil, to control said first field transistor to change the current through said field coil towards a field coil current set point, to calculate a speed error based on said speed command and said determined motor speed, and to control said first, second, third, and fourth armature transistors to reduce said speed error.

2. The system for controlling a DC motor of claim 1, wherein said processor is adapted to turn on said first field transistor to increase current flowing through said field coil, and to turn off said first field transistor to decrease current flowing through said field coil.

3. The system for controlling a DC motor of claim 1, wherein said processor is adapted to increase said current through said armature in a first direction by turning on said first and fourth armature transistors and turning off said second and third armature transistors, and to increase said current through said armature in a second direction by turning on said second and third armature transistors and turning off said first and fourth armature transistors.

4. The system for controlling a DC motor of claim 1, further comprising a bus capacitor connected between said first bus terminal and said second bus terminal.

5. The system for controlling a DC motor of claim 1, further comprising a second field transistor connected in parallel with said first flyback diode.

6. A system for controlling a DC motor, comprising:
a DC power bus comprising a first bus terminal and a second bus terminal;
a first field transistor connected in series with a first flyback diode at a field terminal, said first field transistor and said first flyback diode being connected between said first and second bus terminals;
a field coil connected in series with a brake coil, said field and brake coil connected between said field terminal and a first armature terminal;
a first current sensor adapted to detect the current flowing through said field coil;
a first armature transistor connected in series with a second armature transistor at said first armature terminal; said first and second armature transistors being connected between said first and second bus terminals, said first armature transistor connected in parallel with a second flyback diode;
a third armature transistor connected in series with a fourth armature transistor at a second armature terminal; said third and fourth armature transistors being connected between said first and second bus terminals, said third armature transistor connected in parallel with a third flyback diode;
an armature coil connected between said first armature terminal and said second armature terminal;
a second current sensor adapted to detect the current flowing through said armature coil;
a processor adapted to receive a speed command, to determine a motor speed based on said current flowing through said field coil, said current flowing through said armature coil, and an average voltage across said armature coil, to control said first field transistor to change the current through said field coil towards a field coil current set point, to calculate a speed error based on said speed command and said determined motor speed, and to control said first, second, third, and fourth armature transistors to reduce said speed error.

7. The system for controlling a DC motor of claim 6, wherein said processor is adapted to turn on said first field transistor to increase current flowing through said field coil, and to turn off said first field transistor to decrease current flowing through said field coil.

8. The system for controlling a DC motor of claim 6, wherein said processor is adapted to increase said current through said armature in a first direction by turning on said first and fourth armature transistors and turning off said second and third armature transistors, and to increase said current through said armature in a second direction by turning on said second and third armature transistors and turning off said first and fourth armature transistors.

9. The system for controlling a DC motor of claim 6, further comprising a bus capacitor connected between said first bus terminal and said second bus terminal.

10. The system for controlling a DC motor of claim 6, further comprising a second field transistor connected in parallel with said first flyback diode.

11. The system for controlling a DC motor of claim 6, further comprising a dynamic brake switch connected in series with a dynamic brake resistor, said dynamic brake switch and dynamic brake resistor being connected between said second armature terminal and a brake terminal located between said field coil and said brake coil, wherein said dynamic brake switch is adapted to be closed when said system is powered down.

12. The system for controlling a DC motor of claim 6, further comprising:
a power limit switch, adapted to control first and second normally closed contacts, and first and second normally open contacts, said first normally closed contact connected between said field coil and said first armature terminal, said second normally closed contact connected between said second armature terminal and a first end of said armature coil, said first normally open contact connected between said first end of said armature coil and a power limit diode, said power limit diode connected in parallel across said field coil, said second normally open contact connected in series with a limit switch resistor, and second normally open contact and said limit switch resistor connected across said first armature terminal and said brake terminal.

13. The system for controlling a DC motor of claim 12, wherein said power limit switch is adapted to energize said first and second normally closed contacts and said first and second normally open contacts if a hoist approaches a physical limit.

14. The system for controlling a DC motor of claim 6, wherein a plurality of motors are connected to said power bus, such that at least a portion of current generated by one of said plurality of motors is utilized by another of said plurality of motors.

15. The system for controlling a DC motor of claim 14, wherein said another of said plurality of motors comprises a resistor/contactor control.

16. The system for controlling a DC motor of claim 6, further comprising a generator-motor set connected to said DC power bus, and a DC motor operable with said armature coil and said field coil to transfer energy to said generator-motor set through said DC power bus when said DC motor is in an energy generating condition.

17. A method of controlling a DC motor in a DC motor control system comprising a DC power bus comprising a first bus terminal and a second bus terminal, a first field transistor connected in series with a first flyback diode, said first field transistor and said first flyback diode being connected between said first and second bus terminals; a field coil connected in series with a brake coil, said field and brake coil connected in parallel with said first flyback diode, a first current sensor adapted to detect the current flowing through said field coil, a first armature transistor connected in series with a second armature transistor at a first armature terminal, said first and second armature transistors being connected between said first and second bus terminals, said first armature transistor connected in parallel with a second flyback diode, a third armature transistor connected in series with a fourth armature transistor at a second armature terminal, said third and fourth armature transistors being connected between said first and second bus terminals, said third armature transistor connected in parallel with a third flyback diode, an armature coil connected between said first armature terminal and said second armature terminal, and a second current sensor adapted to detect the current flowing through said armature coil, the method comprising the steps of:
receiving a speed command;
determining a motor speed based on said current flowing through said field coil, said current flowing through said armature coil, and an average voltage across said armature coil;
controlling said first field transistor to change the current through said field coil towards a field coil current set point;
calculating a speed error based on said speed command and said determined motor speed; and
controlling said first, second, third, and fourth armature transistors to reduce said speed error.

18. The method of controlling a DC motor as in claim 17, wherein said step of controlling said first field transistor comprises:
turning on said transistor to increase current flowing through said field coil, and turning off said first field transistor to decrease current flowing through said field coil.

19. The method of controlling a DC motor as in claim 17 wherein said step of controlling said first, second, third, and fourth armature transistors comprises:
turning on said first and fourth armature transistors and turning off said second and third armature transistors to increase said current through said armature in a first direction; and
turning on said second and third armature transistors and turning off said first and fourth armature transistors to increase said current through said armature in a second direction.

20. A method of controlling a DC motor in a DC motor control system comprising a DC power bus comprising a first bus terminal and a second bus terminal, a first field transistor connected in series with a first flyback diode at a field terminal, said first field transistor and said first flyback diode being connected between said first and second bus terminals, a field coil connected in series with a brake coil, said field and brake coil connected between said field terminal and a first armature terminal, a first current sensor adapted to detect the current flowing through said field coil, a first armature transistor connected in series with a second armature transistor at said first armature terminal, said first and second armature transistors being connected between said first and second bus terminals, said first armature transistor connected in parallel with a second flyback diode, a third armature transistor connected in series with a fourth armature transistor at a second armature terminal, said third and fourth armature transistors being connected between said first and second bus terminals, said third armature transistor connected in parallel with a third flyback diode, an armature coil connected between said first armature terminal and said second armature terminal, and a second current sensor adapted to detect the current flowing through said armature coil, the method comprising the steps of:
receiving a speed command;
determining a motor speed based on said current flowing through said field coil, said current flowing through said armature coil, and an average voltage across said armature coil;
controlling said first field transistor to change the current through said field coil towards a field coil current set point;
calculating a speed error based on said speed command and said determined motor speed; and
controlling said first, second, third, and fourth armature transistors to reduce said speed error.

21. The method of controlling a DC motor of claim 20, wherein said step of controlling said first field transistor comprises:
turning on said first field transistor to increase current flowing through said field coil; and
turning off said first field transistor to decrease current flowing through said field coil.

22. The method of controlling a DC motor of claim 20, wherein said step of controlling said first, second, third and fourth armature transistors comprises the steps of:
turning on said first and fourth armature transistors and turning off said second and third armature transistors to increase said current through said armature in a first direction; and
turning on said second and third armature transistors and turning off said first and fourth armature transistors to increase said current through said armature in a second direction.

23. The method of controlling a DC motor of claim 20, wherein said system further comprises a dynamic brake switch connected in series with a dynamic brake resistor, said dynamic brake switch and dynamic brake resistor being connected between said second armature terminal and a brake terminal located between said field coil and said brake coil, wherein said dynamic brake switch is adapted to be closed when said system is powered down.

24. The method of controlling a DC motor of claim 20, wherein said system further comprises:
a power limit switch, adapted to control first and second normally closed contacts, and first and second normally open contacts, said first normally closed contact connected between said field coil and said first armature terminal, said second normally closed contact connected between said second armature terminal and a first end of said armature coil, said first normally open contact connected between said first end of said armature coil and a power limit diode, said power limit diode connected in parallel across said field coil, said second normally open contact connected in series with a limit switch resistor, and second normally open contact and said limit switch resistor connected across said first armature terminal and said brake terminal.

25. The method of controlling a DC motor of claim 24, further comprising the step of energizing said first and second normally closed contacts and said first and second normally open contacts if a hoist approaches a physical limit.
